(19) United States
(12) Patent Application Publication
(10) Pub. No.: US 2014/0055010 A1
(43) Pub. Date: Feb. 27, 2014

(54) POWER GENERATOR INTEGRATED WITH BEARING

(71) Applicants: Eugene Sigal, Zoetermeer (NL); Andreas Clemens Van Der Ham, Utrecht (NL)

(72) Inventors: Eugene Sigal, Zoetermeer (NL); Andreas Clemens Van Der Ham, Utrecht (NL)

(21) Appl. No.: 13/995,962

(22) PCT Filed: Dec. 20, 2010
(86) PCT No.: PCT/EP2010/007792

§ 371 Date: Oct. 31, 2013

(51) Int. Cl. H02K 21/04; H02K 11/00

(52) U.S. Cl. CPC H02K 21/042; H02K 11/0073
USPC 310/68 B

(57) ABSTRACT

A bearing has a first ring (102) and a second ring (104) configured for coaxial rotation with respect to each other, and a generator for generating electric power in operational use of the bearing. The generator has a first arrangement (112) mounted in a fixed position with respect to the first ring, and a second arrangement (114) mounted in a fixed position with respect to the second ring. Each of the first arrangement and the second arrangement comprises one or more coils (122, 128) and one or more magnets (118, 120, 124, 126) arranged in a circumferential direction (116) of the rings. The generator is therefore configured to supply power to circuitry mounted so as to be stationary with a ring.

### FIELD OF THE INVENTION

The invention relates to a bearing comprising a first ring and a second ring that are configured for coaxial rotation around an axis with respect to each other in a circumferential direction in operational use of the bearing, and further comprising a generator for generating electric power in operational use of the bearing. The invention also relates to a machine comprising a bearing and a generator.

### BACKGROUND ART

A combination of a bearing and a generator for generating electric power, physically integrated with the bearing, is known in the art. The generator of such a combination is used for, e.g., powering electronic circuitry that has one or more sensors, accommodated at the bearing and configured for monitoring the condition of the bearing in operational use of the bearing. The electronic circuitry may comprise a transcoder and a memory for storing data that is representative of the sensor signals. The data can be read out from the memory at a later time. The electronic circuitry may comprise a radiofrequency (RF) transmitter for wirelessly transmitting the data to a receiver external to the bearing. All these electronic components of the electronic circuitry receive their power from the generator. Alternatively, or in addition, the generator is used for providing the bearing with anodic or cathodic protection from corrosion.

Typically, one of the first ring and the second ring of such a bearing accommodates one or more magnets, and the other one of the first ring and the second ring accommodates one or more coils. In operational use of the bearing, the first ring and the second ring are rotating relative to one another, and the magnets at the one ring are travelling past the coils at the other ring. As a result, the magnetic field at the location of an individual one of the coils varies during each rotation of the first ring and second ring relative to one another. As known, a varying magnetic field induces an electromotive force in a closed electrical circuit. Accordingly, the mechanical energy of the relative rotation of the first ring and the second ring is converted into electrical energy.

### SUMMARY OF THE INVENTION

The inventors have realized that known bearings, equipped with integrated power generators, use magnets at only a specific one of the first ring and second ring, and coils on the other ring. As a result, electric power is available at the specific ring that accommodates the coils. A drawback of the known bearing with integrated generator is, therefore, that special measures have to be taken to supply power, generated at the specific ring, in a reliable manner to electronic circuitry accommodated at the other ring. Bearings are essential components for almost any piece of machinery and are typically mass-produced. It would be costly to produce the same type of bearing in both a version with the magnets on the first ring and the coils on the second ring, and another version with the magnets on the second ring and the coils on the first ring, in order to cater to different applications having the electronic circuitry either on the second ring or on the first ring.

The inventors propose a bearing, comprising a first ring and a second ring configured for coaxial rotation with respect to each other around an axis in a circumferential direction in operational use of the bearing, and further comprising a generator for generating electric power in operational use of the bearing. The generator comprises a first arrangement mounted in a fixed position with respect to the first ring, and a second arrangement mounted in a fixed position with respect to the second ring. Thus, the first arrangement and the second arrangement are configured for coaxial rotation with respect to each other in operational use of the bearing. The first arrangement extends in a circumferential direction with respect to the axis and comprises one or more first magnetic elements, each respective one of the first magnetic elements being configured for generating a respective first component of a magnetic field, and one or more first power elements, each respective one of the first power elements being configured for supplying a respective first amount of electric power upon experiencing a respective change in the magnetic field at a respective first location of the respective first power element. The second arrangement extends in the circumferential direction and comprises one or more second magnetic elements, each respective one of the second magnetic elements being configured for generating a respective second component of the magnetic field, and one ore more second power elements, each respective one of the second power elements being configured for supplying a respective second amount of electric power upon experiencing a respective change in the magnetic field at a respective second location of the respective second power element.

The first arrangement is formed by the one or more first magnetic elements and the one or more first power elements, and the second arrangement is formed by the one or more second magnetic elements and the one or more second power elements. The first arrangement is positioned so as to be fixed with respect to the first ring, and the second arrangement is positioned so as to be fixed with respect to the second ring. As a consequence, the rotation of the first ring and the second ring relative to one another brings about a relative rotation of the first arrangement and the second arrangement. The first arrangement and the second arrangement are accommodated relative to one another in such a manner, that the first power elements travel through the components of the magnetic field generated by the second magnetic elements, and the second power elements travel through the other components of the magnetic field generated by the first magnetic elements in operational use of the bearing. Accordingly, power can easily be supplied to circuitry fixed with respect to either one of the rings.

The bearing according to the invention comprises, e.g., any of a rolling element bearing and a plain bearing. The bearing of the invention comprises, for example, a radial bearing for supporting a radial load, such a as a deep-groove ball-bearing or a cylindrical roller bearing, or comprises an axial bearing (e.g., a thrust bearing) for supporting an axial load, or comprises a hybrid bearing for supporting a combination of an axial load and a radial load such as, e.g., taper roller bearings.

Each particular one of the first magnetic elements and the second magnetic elements can be implemented in a variety of manners, e.g., as a permanent discrete magnet, as an electromagnet, as a permanent discrete magnet or electromagnet in combination with a flux guide of ferromagnetic material so as to guide the magnetic field in a controlled manner towards a particular region in space, etc., or as a combination of these implementations.

Each particular one of the first power elements and the second power elements can be implemented in a variety of manners, e.g., an inductance or coil implemented as a helix (3-dimensional), or a coil implemented as a spiral (2-dimensional) printed on a dielectric substrate. The preferred orientation of the coil is determined by the field lines of the magnetic field that induced a voltage in the coil. If the magnetic field experienced by the first arrangement is strongest in a circumferential direction with respect to the axis of the bearing, the axis of the coil is preferably aligned with the circumferential direction at the location of the coil. If the magnetic field experienced by the first arrangement is strongest in a radial direction with respect to the axis of the bearing, the axis of the coil is preferably aligned with the radial direction at the location of the coil. Similar considerations apply to a coil in the second arrangement. The spatial pattern of the field lines of the magnetic field are determined by the first magnetic elements and the second magnetic elements combined, and is a matter of design choice.

The first arrangement may be accommodated at the first ring, e.g., in a suitably shaped circumferential recess in the first ring, or on a suitably shaped circumferential flank of the first ring, or on a suitably shaped carrier attached to the first ring. Similarly, the second arrangement may be accommodated at the second ring, e.g., in a suitably shaped circumferential recess in the second ring or on a suitably shaped flank of the second ring or on a suitably shaped carrier attached to the second ring.

Alternatively, in an embodiment of the bearing of the invention, the bearing comprises a seal between the first ring and the second ring. The seal is operative to retain a lubricant in a space between the first ring and the second ring or to prevent ingress of a contaminant into the space. The seal comprises at least one of a first part attached to the first ring and a second part attached to the second ring. That is, the seal may be implemented by means of a single part that is attached to either the first ring or the second ring and that is in sliding contact with the other one of the first ring and the second ring in operational use of the bearing. Alternatively, the seal may be implemented by means of a first part attached to the first ring and a second part attached to the second ring wherein, in operational use of the bearing, the first part and the second part remain in sliding contact with each other at a region of the seal where the first part and the second part overlap. In the embodiment, at least one of the first arrangement and the second arrangement is accommodated at the seal.

A seal is typically comprises an elastic, low-friction material, such as e.g. polytetrafluoroethylene (PTFE). PTFE is an electrical insulator and is used as a substrate for printed circuit boards (PCBs). Reportedly, electric currents passing through the bearing reduce the service life of the bearing. Accordingly, accommodating the first arrangement and the second arrangement at the seal has advantages over accommodating a respective one of these arrangements at the respective one of the rings. A first advantage is that the first ring or the second ring does not need to be adapted, e.g., by providing a groove or a profiled rim on the bearing's flank, for accommodating the relevant one of the first arrangement and the second arrangement. A second advantage is that the electrical circuitry can be created at a surface of the seal's material using, e.g., photolithographic technologies. A third advantage is that there is a galvanic separation between, on the one hand, the first ring and the second ring and, on the other hand, the electronic circuitry. As result thereof, the paths of the currents in the electronic circuitry do not pass through the bearing proper. As a fourth advantage, the bearing can be mounted on a shaft in a conventional manner as the electronic circuitry will not be exposed to drive-up forces applied to the bearing when the bearing is being mounted cold on a shaft that has an interference fit matching the bearing. As a fifth advantage, the surface of the seal provides an area for mounting auxiliary components such as an auxiliary battery, an antenna, etc.

In a further embodiment, of the bearing according to the invention, the first arrangement comprises a specific one of the first power elements between a specific pair of the first magnetic elements. The first magnetic elements of the specific pair are configured to generate the first components of the magnetic field having opposite orientations at a path traversed by the second arrangement with respect to the first arrangement in operational use of the bearing. The second arrangement comprises a further specific one of the second power elements between a further specific pair of the second magnetic elements. The second magnetic elements of the further specific pair are configured to generate the second components of the magnetic field having opposite orientations at a further path traversed by the first arrangement with respect to the second arrangement in operational use of the bearing.

Optionally, the first arrangement comprises a first piece of ferromagnetic material for guiding the magnetic field lines, and the second arrangement comprises a second piece of ferromagnetic material for guiding the magnetic field lines. As a result, the rate of change of the magnetic flux as experienced by the first power elements and the second power elements is increased in operational use of the bearing. If the first arrangement is mounted at the first ring, and the second arrangement is mounted at the second ring, the first ring and the second ring may serve as the first piece of ferromagnetic material and as the second piece of ferromagnetic material, respectively.

In a simple configuration of the above further embodiment, the first arrangement comprises only a single first power element, flanked by a pair of first magnetic elements of opposite polarity, and the second arrangement comprises only a single second power element, flanked by a pair of second magnetic elements of opposite polarity. This simple configuration forms a variable-reluctance generator with only two magnetic elements in either one of the first arrangement and the second arrangement. An advantage of this configuration is that only four magnetic elements are needed to create a generator, which is less expensive than another configuration with more than four magnetic elements of the same strength.

In another embodiment of a bearing according to the invention, wherein the first arrangement comprises a specific one of the first power elements interposed in a first series of four or more of the first magnetic elements arranged in the circumferential direction. The first magnetic elements are configured to generate the first components of the magnetic field that have a uniform first orientation at a path traversed by the second arrangement with respect to the first arrangement in operational use of the bearing. The second arrangement comprises a specific one of the second power elements interposed in a second series of four or more of the second magnetic elements arranged in the circumferential direction. The second magnetic elements are configured to generate the second components of the magnetic field that have a uniform second orientation at a further path traversed by the first arrangement with respect to the second arrangement in operational use of the bearing. The first orientation equals the second orientation.

The first series of the first magnets and the second series of the second magnets extend in the circumferential direction. The specific first power element and the specific second power element experience changes in the magnetic flux each time they pass a particular one of the second magnetic elements and a particular one of the first magnetic elements, respectively. As a result, a respective voltage is induced in the respective one of the specific first power element and the specific second power element. If the number of first magnetic elements and the number of second magnetic elements is increased, the power, generated per revolution of the first arrangement and the second arrangement relative to each other, is increased.

In another embodiment of a bearing according to the invention, the first arrangement comprises a first alternating sequence of the first magnetic elements and the first power elements in the circumferential direction. The second arrangement comprises a second alternating sequence of the second magnetic elements and the second power elements in the circumferential direction.

The first components of the magnetic field generated by the first magnetic elements have a uniform first orientation at a path traversed by the second arrangement in operational use of the bearing. The second components of the magnetic field generated by the second magnetic components have a uniform second orientation at a further path traversed by the first arrangement in operational use of the bearing. The first orientation equals the second orientation.

In this embodiment, the first alternating sequence may extend all the way along the circumference of the first ring or only along a portion of the circumference of the first ring. Similarly, the second alternating sequence mat extend all the way along the circumference of the second ring or only along a portion of the circumference of the second ring. The magnitude of the electric power generated by the generator depends on, for example, the strength of the magnetic field, the electric power generation capability per individual one of the first power elements and the second power elements, and the frequency of the change in the magnetic field as experienced by an individual one of the first power elements and the second power elements. The frequency depends on the relative speed of rotation of the first arrangement and the second arrangement relative to one another, and on the number of first magnetic elements and second magnetic elements of the generator.

Note that the first arrangement and the second arrangement in any of the above embodiments may, but need not, be configured for generating the same magnitude of electric power. For example, a first number of the first magnetic elements in the first arrangement may be larger than a second number of the second magnetic elements in the second arrangement, the first magnetic elements and the second magnetic elements being uniform. If the first power elements and the second power elements are uniform as well, the electric power generated by an individual one of the second power elements is higher than the electric power generated by an individual one of the first power elements. This owes to the fact that, in operational use of the bearing, the individual second power element experiences more changes of the magnetic field per unit of time than the individual first power element. The electric circuitry rotating with the first ring may need not as much electric power as the other electronic circuitry rotating with the second ring.

Consider a radial bearing wherein the first ring is the outer ring and the second ring is the inner ring. Note that the circumference of the outer ring is longer than the circumference of the inner ring. Accordingly, if the first power elements and the second power elements are uniform, and if the first magnetic elements and the second magnetic elements are likewise uniform, a larger number of power elements and magnetic elements can be accommodated at the outer ring than at the inner ring. If more power is required by the circuitry rotating with the inner ring than by the circuitry rotating with the outer ring, the second arrangement rotating with the outer ring may be provided with a larger number of magnetic elements and a smaller number of power elements than are accommodated in the first arrangement rotating with the inner ring.

Note that in operational use of the bearing, the attracting and repelling interactions between the first magnetic elements and the second magnetic elements, when they are passing each other, exert opposite torques on the first ring and the second ring around the axis. As a result, acceleration and deceleration occur in the relative movement of the first ring and second ring in the circumferential direction. This may not be a problem if the rotational inertia of the part of the bearing and its load that move with regard to an inertial frame of reference, is large enough. If the rotational inertia is not large enough, the repeated acceleration and deceleration causes oscillations that may affect the integrity of the bearing and/or the integrity of the machinery of which the bearing forms a functional part. In order to solve this, consider the bearing to be a radial bearing with the first arrangement and the second arrangement mounted on the same side of the bearing, i.e., substantially in the same plane perpendicular to the axis of the bearing. Consider now mounting a third arrangement and a fourth arrangement on the other side of the bearing. The third arrangement is mounted in a fixed position with respect to the first ring, and the fourth arrangement is mounted in a fixed position with respect to the second ring. The third arrangement extends in the circumferential direction and comprises one or more third magnetic elements, each respective one of the third magnetic elements being configured for generating a respective third component of a further magnetic field, and one or more third power elements, each respective one of the third power elements being configured for supplying a respective third amount of electric power upon experiencing a respective change in the further magnetic field at a respective third location of the respective third power element. The fourth arrangement extends in the circumferential direction and comprises one or more fourth magnetic elements, each respective one of the fourth magnetic elements being configured for generating a respective fourth component of the further magnetic field, and one ore more fourth power elements, each respective one of the fourth power elements being configured for supplying a respective fourth amount of electric power upon experiencing a respective change in the further magnetic field at a respective fourth location of the respective fourth power element. That is, each respective one of the sides of the radial bearing comprises a respective generator of similar configuration. If the third arrangement and fourth arrangement are properly positioned in the circumferential direction with respect to the first arrangement and the second arrangement, at least some of the torques caused by one of the generators can be canceled by the torques generated at the other generator. As the torques are applied in different planes, a lower-order torque may remain that tends to tilt the bearing out of the bearing's plane.

The invention further relates to a machine equipped with one or more bearings according to the invention. More specifically, the invention relates to a machine that comprises a first machine part, a second machine part and a bearing. The bearing comprises a first ring and a second ring configured for coaxial rotation with respect to each other around an axis in a circumferential direction in operational use of the bearing. The first ring has a fixed position with respect to the first machine part and the second ring has a fixed position with respect to the second machine part for enabling the first machine part and the second machine part to rotate relative to one another. The machine comprises one or more electric or electronic circuits at at least one of the first machine part, the second machine part, and the bearing. The machine comprises a generator for generating electric power in operational use of the bearing for supply of the one or more electric or electronic circuits in operational use of the bearing. The generator comprises a first arrangement mounted in a fixed position with respect to the first ring, and a second arrangement mounted in a fixed position with respect to the second ring. The first arrangement and the second arrangement are configured for coaxial rotation with respect to each other in operational use of the bearing. The first arrangement extends in a circumferential direction with respect to the axis and comprises: one or more first magnetic elements, each respective one of the first magnetic elements being configured for generating a respective first component of a magnetic field, and one or more first power elements, each respective one of the first power elements being configured for supplying a respective first amount of electric power upon experiencing a respective change in the magnetic field at a respective first location of the respective first power element. The second arrangement extends in the circumferential direction and comprises: one or more second magnetic elements, each respective one of the second magnetic elements being configured for generating a respective second component of the magnetic field, and one ore more second power elements, each respective one of the second power elements being configured for supplying a respective second amount of electric power upon experiencing a respective change in the magnetic field at a respective second location of the respective second power element.

The generator may, but need not, be attached to, or physically integrated with, the bearing proper. One or both of the elements of the generator, i.e., the first arrangement and the second arrangement, may alternatively be attached to, or physically integrated with, parts of the machine that are enabled by the bearing to rotate freely with respect to each other in operational use.

### BRIEF DESCRIPTION OF THE DRAWING

The invention is explained in further detail, by way of example and with reference to the accompanying drawing, wherein:

FIG. 1 is a diagram of a first bearing with a generator according to the invention;

FIG. 2 is a diagram of a second bearing with a generator according to the invention;

FIGS. 3 and 4 are diagrams to illustrate operation of an example configuration of the generator;

FIG. 5 is a diagram of another configuration of the generator; and

FIGS. 6, 7 and 8 are diagrams illustrating examples of a generator accommodated at a seal of a bearing.

Throughout the Figures, similar or corresponding features are indicated by same reference numerals.

### DETAILED EMBODIMENTS

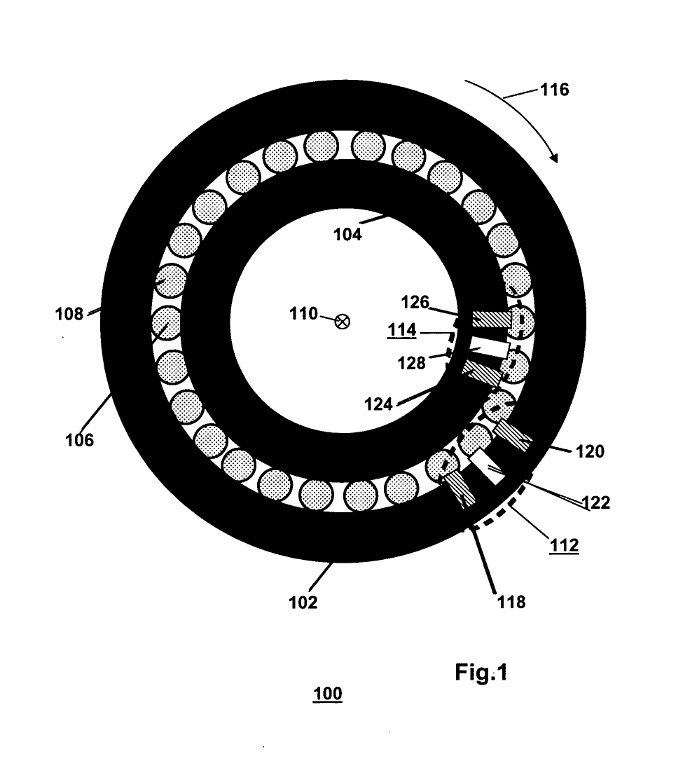

FIG. 1 is a diagram illustrating a first bearing 100 with components for implementing a generator for generating electric power in operational use of the first bearing 100. The first bearing 100 is a rolling element bearing comprising a first ring 102, a second ring 104 and a plurality of rolling elements positioned between the first ring 102 and the second ring 104. In order to not obscure the drawing, only a first one and a second one of the rolling elements are indicated with reference numerals 106 and 108, respectively. The first ring 102 and the second ring 104 are arranged for coaxial rotation with respect to each other around a common axis 110 in operational use of the first bearing 100. The diagram of Fig.1 shows the first bearing 100 in an orientation, wherein the common axis 110 runs perpendicularly to the plane of the drawing. Accordingly, the diagram shows the first bearing 100 with a first flank of the first ring and a second flank of the second ring 104 facing the viewer.

The generator comprises a first arrangement 112 mounted in a fixed position with respect to the first ring 102, and a second arrangement 114 mounted in a fixed position with respect to the second ring 104. The first arrangement 112 and the second arrangement 114 are configured for coaxial rotation with respect to each other in operational use of the first bearing 100. The first arrangement 112 extends in a circumferential direction 116 with respect to the axis and comprises a first magnetic element 118 and a further first magnetic element 120, configured for generating a first component of a magnetic field and a further first component of the magnetic field, respectively.

For example, the first magnetic element 118 comprises a permanent magnet and the further first magnetic element 120 comprises a further permanent magnet. Alternatively, the first magnetic element 118 and the further first magnetic element 120 form the two poles of a single permanent magnet. Alternatively, the first magnetic element 118 comprises a permanent magnet and the further first magnetic element 120 comprises a piece of ferromagnetic material for guiding the magnetic flux from the permanent magnet of the first magnetic element 118. Alternatively, the first magnetic element 118 comprises a piece of ferromagnetic material and the further first magnetic element 120 comprises a further piece of ferromagnetic material, and both the piece and the further piece are operative to guide the flux from the magnetic field in their vicinity. An electromagnet can be used in above implementations instead of the permanent magnet mentioned above.

The first arrangement 112 further comprises a first power element 122, configured for supplying a respective first amount of electric power upon experiencing a change in the magnetic field at a first location of the first power element 122. The first power element 122 comprises, for example, an inductance, e.g., a coil (a 3-dimensional helix or a 2-dimensional spiral).

The second arrangement 114 extends in the circumferential direction 116 and comprises a second magnetic element 124 and a further second magnetic element 126. The second magnetic element 124 generates a second component of the magnetic field, and the further second magnetic element 126 generates a further second component of the magnetic field. The second magnetic element 124 and the further second magnetic element 126 can be implemented in a variety of manners, examples of which have been given above with regard to the first magnetic element 118 and the further first magnetic element 120 of the first arrangement 112. However, at least one of the first arrangement 112 and the second arrangement 114 comprises a permanent magnet or an electromagnet.

The second arrangement 114 also comprises a second power element 128, configured for supplying a second amount of electric power upon experiencing a change in the magnetic field at a second location of the second power element 128. The second power element 128 comprises, for example, an inductance, e.g., a coil (a 3-dimensional helix or a 2-dimensional spiral).

The first arrangement 112 and the second arrangement 114 lie substantially in the same plane perpendicular to the axis 110. When the first ring 102 and the second ring 104 are rotating relative to each other in operational use of the first bearing 100, the first arrangement 112 and the second arrangement 114 pass each other, owing to the fact that the first arrangement 112 has a fixed location relative to the first ring 102 and the second arrangement 114 has a fixed location relative to the second ring 104.

The first arrangement 112 and the second arrangement 114 may be accommodated in a variety of manners.

In a first implementation, the first arrangement 112 and the second arrangement 114 are both accommodated at the first bearing 100. One or both of the first arrangement 112 and the second arrangement 114 can be mounted at a respective flank of a respective one of the first ring 102 and the second ring 104, the respective flank being substantially perpendicular to the axis 110.

Alternatively, a specific one of the first arrangement 112 and the second arrangement 114 can be mounted at a seal (not shown here) of the first bearing 100, and the other one of the first arrangement 112 and the second arrangement 114 is mounted at the relevant one of the first ring 102 and the second ring 104. If the seal comprises a first section that is attached to the first ring 102, and a second section that is attached to the second ring 104, the first arrangement 112 and the second arrangement 114 can both be mounted at the seal.

For a second implementation, consider the first bearing 100 forming a functional component of a machine (not shown) in order to enable a first machine part (e.g., a shaft) to rotate freely relative to a second machine part (e.g., a housing). The first ring 102 has then a fixed position with respect to the first machine part, and the second ring 104 has a fixed position with respect to the second machine part. The first arrangement 112 may then be accommodated at the first part of the machine, and the second arrangement 114 may then be accommodated at the second part of the machine. Alternatively, one of the first arrangement 112 and the second arrangement 114 is mounted at the relevant one of the first machine part and the second machine part, and the other one of the first arrangement 112 and the second arrangement 114 is mounted at the relevant one of the first ring 102 and the second ring 104 or at the seal of the first bearing 100.

When the first arrangement 112 and the second arrangement 114 pass each other in operational use of the first bearing 100, each of the first magnetic element 118 and the further first magnetic element 120 of the first arrangement 112 causes the magnetic field at the second power element 128 in the second arrangement 114 to change. As a result, a voltage is induced in the second power element 128 that can be used to supply electric or electronic circuitry (not shown) that is installed in a fixed position with respect to the second ring 104. Likewise, when the first arrangement 112 and the second arrangement 114 pass each other in operational use of the first bearing 100, each of the second magnetic element 124 and the further second magnetic element 126 of the second arrangement 114 causes the magnetic field at the first power element 122 in the first arrangement 112 to change. As a result, a voltage is induced in the first power element 122 that can be used to supply electric or electronic circuitry (not shown) that is installed in a fixed position with respect to the first ring 102.

Note that each of the first arrangement 112 and the second arrangement 114 is shown, by way of example, as comprising a respective pair of magnetic elements and a respective power element. Each of the first arrangement 112 and the second arrangement 114 may comprise only a single magnetic element or more than two magnetic elements Likewise, each of the first arrangement 112 and the second arrangement 114 may comprise two or more respective power elements.

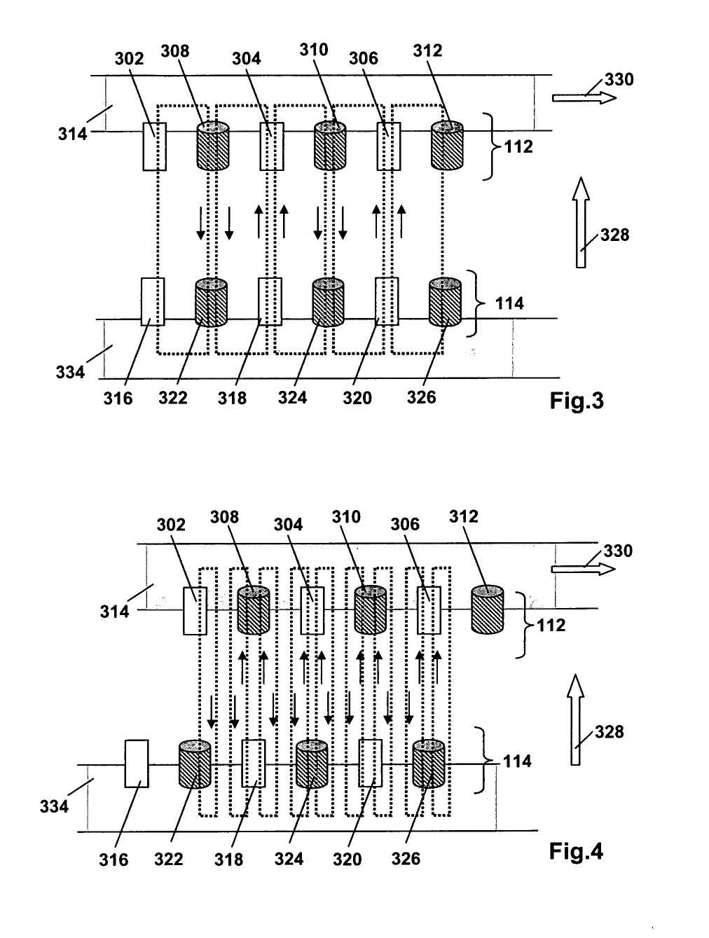

The configuration of the generator in the diagram of FIG. 1 preferably has the first magnetic element 118 and the further first magnetic element 120 implemented in such a way that the first magnetic element 118 generates a first component of the magnetic field at the path traversed by the second arrangement 114 that has a specific direction relative to the first ring 102, and that the further first magnetic element 120 generates a further first component of the magnetic field at the path traversed by the second arrangement 114 in another direction opposite to the specific direction. For example, the specific direction is radially inwards and the other direction is radially outwards. As another example, the specific direction is clockwise in the circumferential direction 116 and the other direction is anti-clockwise in the circumferential direction. An advantage of such opposite orientations of components of the magnetic field resides in the fact that the components cooperate constructively at the locations of the first power element 122 and the second power element 128 so that the changes are more pronounced in the magnetic field as experienced by the first power element 122 and the second power element 128, as will be discussed below with reference to FIGS. 3 and 4.

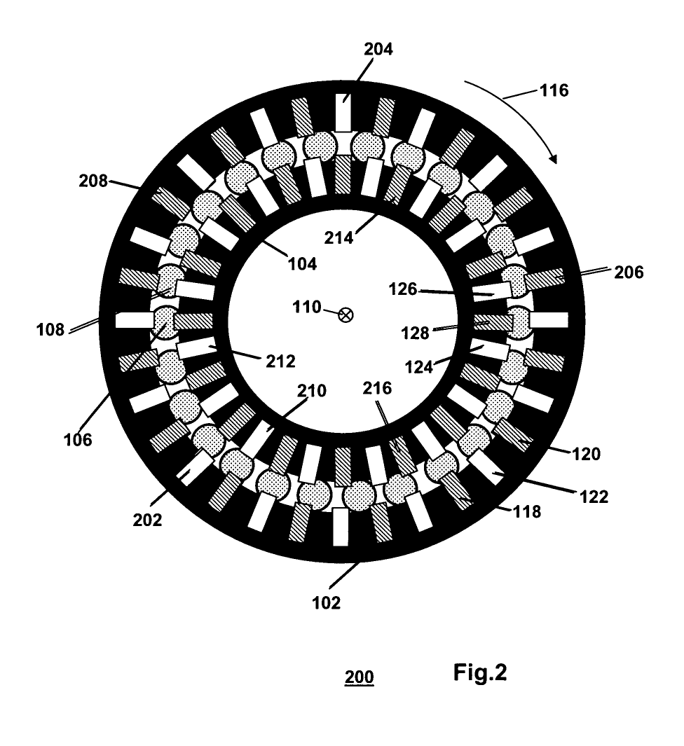

FIG. 2 is a diagram of a second bearing 200 with a generator according to the invention. The second bearing 200 comprises the parts of the first bearing 100 as discussed with reference to the diagram of FIG. 1. The first arrangement 112 now comprises additional first magnetic elements, such as a first additional first magnetic element 202 and a second additional first magnetic element 204, as well as additional first power elements such as a first additional first power element 206 and a second additional first power element 208. Likewise, the second arrangement 114 now comprises additional second magnetic elements, such as a first additional second magnetic element 210 and a second additional second magnetic element 212, as well as additional second power elements such as a first additional second power element 214 and a second additional second power element 216.

In the example of FIG. 2, each of the first arrangement 112 and the second arrangement 114 (not indicated with reference numerals here; see FIG. 1) forms a full circle centered on the axis 110. As discussed earlier, each respective one of the first arrangement 112 and the second arrangement 114 may comprise one or more respective magnetic elements and one or more respective power elements as is deemed suitable for the intended power supply of the circuitry mounted so as to be stationary with the respective one of the first arrangement 112 and the second arrangement 114 in operational use of the bearing. Furthermore, each respective one of the first arrangement 112 and the second arrangement 114 may, but need not, be formed as an unbroken sequence of magnetic elements and power elements. For example, a respective one of the first arrangement 112 and the second arrangement 114 comprises multiple segments, each with one or more first magnetic elements and one or more first power elements, wherein a circumferential distance between adjacent one of the multiple segments is larger than a further circumferential distance between adjacent ones of the power elements and the magnetic elements of a particular one of the segments. That is, the circumferential spatial distribution as well as the number of power elements and the number of magnetic elements per individual one of the first arrangement 112 and the second arrangement 114 is determined in dependence of the technical application of the power supply per individual piece of electric or electronic circuitry that is mounted stationary with respect to the individual arrangement.

Operation of the generator of the first bearing 100 and the second bearing 200 is explained with reference to FIGS. 3 and 4. The rolling elements have been omitted from the diagrams of FIGS. 3 and 4 in order to not obscure the drawing. The flank of the first ring 102 and the flank of the second ring 104 of FIG. 1 are represented only partly and in a manner that ignores the curvature of the flanks in the view of FIG. 1.

FIGS. 3 and 4 illustrate operation of an example of the generator, wherein the first arrangement 112 is formed by an alternating sequence of a plurality of first magnetic elements 302, 304 and 306 and a plurality of first power elements 308, 310 and 312 arranged at a first piece of ferromagnetic material 314 that serves to guide the field lines of the magnetic field. The first piece of ferromagnetic material 314 is mounted stationary with respect to the first ring 102, or may even be implemented by a portion of the first ring 102. The second arrangement 114 is formed by an alternating sequence of a plurality of second magnetic elements 316, 318 and 320, and a plurality of second power elements 322, 324 and 326 arranged at second piece of ferromagnetic material 334 that serves to guide the field lines of the magnetic field. The second piece of ferromagnetic material 334 is mounted stationary with respect to the second ring 104, or may even be implemented by a portion of the second ring 104.

Each respective one of the plurality of the first magnetic elements 302, 304 and 306 and of the plurality of second magnetic elements 316, 318 and 320 generates a respective component of the magnetic field, whose north-south orientation is indicated with a first arrow 328.

In the diagram of FIG. 3, the relative position of the first arrangement 112 and the second arrangement 114 is shown as having a respective one of the plurality of the first magnetic elements 302, 304 and 306 located opposite a respective one of the plurality of second magnetic elements 316, 318 and 320, and as having a respective one of the plurality of first power elements 308, 310 and 312 located opposite a respective one of the plurality of second power elements 322, 324 and 326. Note that the field lines of the magnetic field (represented by dashed lines) are concentrated at the plurality of first power elements 308, 310 and 312 and the plurality of second power elements 322, 324 and 326. Note that the magnetic field at the locations of the first power elements 308, 310 and 312 and of the second power elements 322, 324 and 326 has a direction opposite the direction of the first arrow 328.

In operational use of the first bearing 100 or of the second bearing 200, the first ring 102 and the second ring 104 rotate coaxially relative to one another. In the simplified topology of the diagrams of FIGS. 3 and 4, this relative rotation translates to the first ring 102 moving with respect to the second ring 104 in the direction indicated by a second arrow 330. As a result, the relative position of the first arrangement 112 and the second arrangement 114 changes from the relative position, illustrated in the diagram of FIG. 3, to the relative position, illustrated in the diagram of FIG. 4.

In the diagram of FIG. 4, the relative position of the first arrangement 112 and the second arrangement 114 is shown as having a respective one of the plurality of the first magnetic elements 302, 304 and 306 located opposite a respective one of the plurality of second power elements 322, 324 and 326, and as having a respective one of the plurality of first power elements 308, 310 and 312 located opposite a respective one of the plurality of second magnetic elements 316, 318 and 320. Note that the field lines of the magnetic field (represented by the dashed lines) are again concentrated at the plurality of first power elements 308, 310 and 312 and the plurality of second power elements 322, 324 and 326. Note that the magnetic field at the locations of the first power elements 308, 310 and 312 and of the second power elements 322, 324 and 326 has the direction of the first arrow 328.

In operational use of the first bearing 100 or of the second bearing 200, the relative position assumed by the first arrangement 112 and the second arrangements 114 changes continuously and cyclically between the one of the diagram of FIG. 3 and the other one of the diagram of Fig.4. When the relative position changes in this way, each of the plurality of first power elements 308, 310 and 312 and of the plurality of second power elements 322, 324 and 326 experiences a repeated flipping of the direction of the magnetic field. That is, the magnitude of the change of the magnetic field at the location of a specific one of the power elements is a maximum, and gives rise to a maximum magnitude of the voltage induced per individual power element.

In the diagrams of FIGS. 3 and 4, the magnetic elements have been drawn as generating components of the magnetic in a direction perpendicular to the direction of relative movement of the first arrangement 112 and the second arrangement 114. The orientation of the power elements relative to the direction of relative movement is determined so as to optimize the voltage induced.

In the diagrams of FIGS. 3 and 4, the orientation of the power elements is determined so as to enclose a large number of field lines of the magnetic field. In an alternative embodiment, the magnetic elements are configured to generate the components of the magnetic in a direction parallel to the direction of relative movement of the first arrangement 112 and the second arrangement 114. The orientation of the power elements relative to the direction of movement is then determined so as to optimize the voltage induced. If a specific power element includes a coil, the above may imply that the axis of the coil be rotated so as to get aligned with the direction of relative movement of the first arrangement 112 and the second arrangements 114.

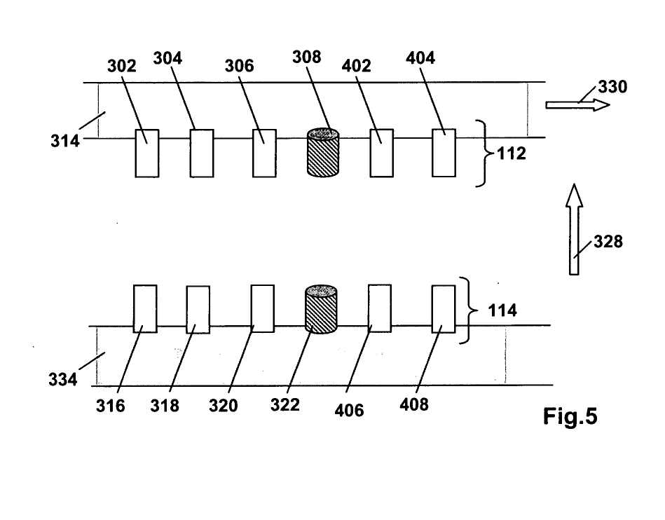

FIG. 5 is a diagram of another configuration of the first arrangement 112 and the second arrangements 114. The first arrangement 112 now comprises at least one first power element 308 and a plurality of the first magnetic elements 302, 304, 306, 402 and 404. The second arrangement 114 now comprises at least one second power element 322 and a plurality of second magnetic elements 316, 318, 320, 406 and 408. The first power element 308 has multiple ones of the plurality of the first magnetic elements 302, 304, 306, 402 and 404 on either side of the first power element 308. Similarly, the second power element 322 has multiple ones of the plurality of second magnetic elements 316, 318, 320, 406 and 408 on either side of the second power element 322. Each of the first magnetic elements 302, 304, 306, 402 and 404 and of the second magnetic elements 316, 318, 320, 406 and 408 generates a component of the magnetic field in the direction of the first arrow 328.

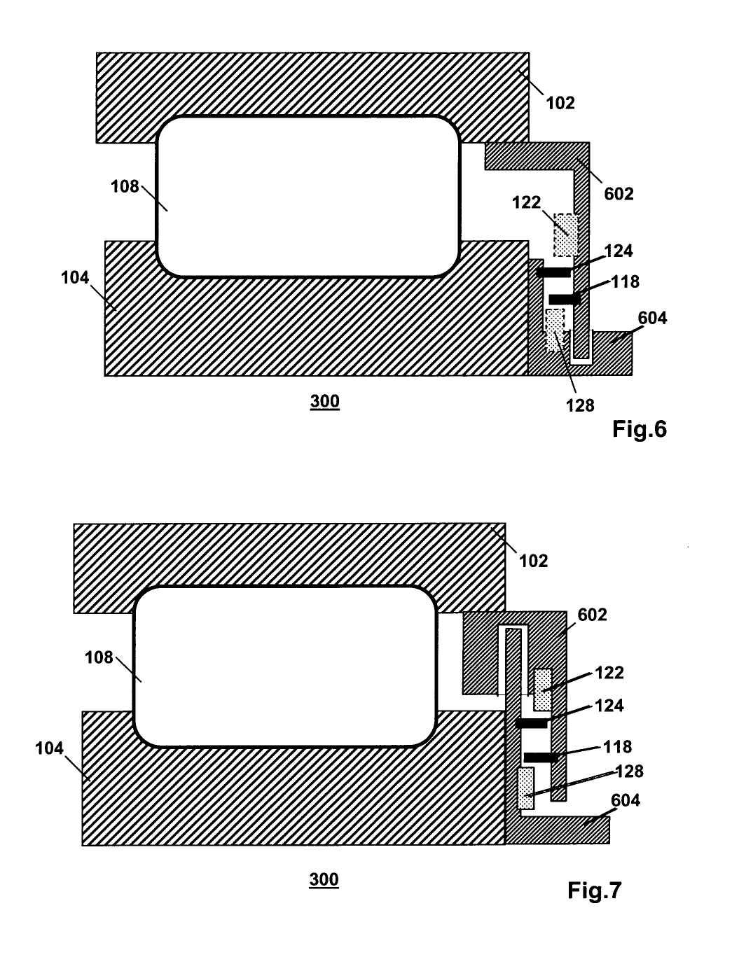

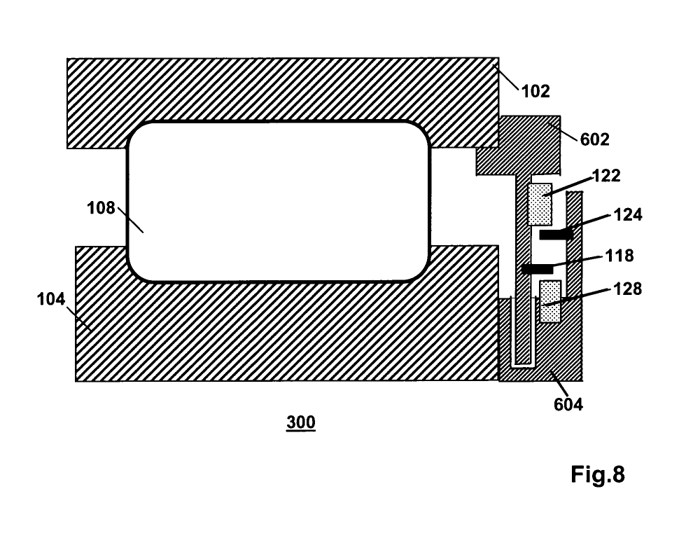

FIGS. 6, 7 and 8 are diagrams illustrating examples of the generator accommodated at a seal of a third bearing 600. The diagrams of FIGS. 7, 8 and 9 represent half of a cross-section through the third bearing 600 in a plane that comprises the rotation axis of the first ring 102 and the second ring 104 of the third bearing, and that cuts through a specific one of the rolling elements 108.

The third bearing 600 comprises a seal that is composed of a first part 602 and a second part 604. The seal serves to close a gap 606 between the first ring 102 and the second ring 104 so as to retain a lubricant in a space between the first ring 102 and the second ring 104 or to prevent ingress of a contaminant into the space. The first part 602 is attached to the first ring 102 and the second part 604 is attached to the second ring 104. The first arrangement 112, symbolized here by the first magnetic element 118 and the first power element 122, is mounted to the first part 602 of the seal. The first power element 122 is shown in dashed lines as the first power element 122 does not lie in the same plane of the cross-section as the first magnetic element 118. The second arrangement 114, symbolized here by the second magnetic element 124 and the second power element 128, is mounted to the second part 604 of the seal. The second power element 128 is shown in dashed lines as the second power element 128 does not lie in the same plane of the cross-section as the second magnetic element 124.

In the configuration of FIG. 6, the first arrangement 112 and the second arrangement 114 are located within the space sealed from the outside world by means of the seal, the first ring 102, the second ring 104 and the plurality of rolling elements. Accommodating the first magnetic element 118 and the second magnetic element 124 in this space may have the advantage that the first magnetic element 118 and the second magnetic element 124 will collect metallic debris caused by the wear and tear of the third bearing 600 over its service life, thus keeping the debris away from the raceways of the third bearing 600.

In the configurations of FIGS. 7 and 8, the first part 602 of the seal and the second part 604 of the seal are configured so as to have the first arrangement 112 and the second arrangement 114 positioned outside the space protected by the seal. The configuration of FIG. 8 has an advantage over the configuration of FIG. 7 if the second ring 104 rotates relative to an inertial frame of reference and the first ring 102 is kept stationary relative to the inertial frame of reference. In the configuration of FIG. 8, if moisture or debris from an outside source is collected between the first part 602 of the seal and the second part 604 of the seal, the centrifugal force will end to remove the moisture and the debris.

1. A bearing, comprising:
a first ring and a second ring configured for coaxial rotation with respect to each other around an axis in a circumferential direction; and
a generator for generating electric power in operational use of the bearing; wherein:
the generator includes a first arrangement mounted in a fixed position with respect to the first ring, and a second arrangement mounted in a fixed position with respect to the second ring; wherein
the first arrangement and the second arrangement are configured for coaxial rotation with respect to each other in operational use of the bearing; wherein
the first arrangement extends in the circumferential direction with respect to the axis and provides:
one or more first magnetic elements, each respective one of the first magnetic elements being configured for generating a respective first component of a magnetic field; and
one or more first power elements, each respective one of the first power elements being configured for supplying a respective first amount of electric power upon experiencing a respective change in the magnetic field at a respective first location of the respective first power element; wherein
the second arrangement extends in the circumferential direction and provides:
one or more second magnetic elements, each respective one of the second magnetic elements being configured for generating a respective second component of the magnetic field; and
one ore more second power elements, each respective one of the second power elements being configured for supplying a respective second amount of electric power upon experiencing a respective change in the magnetic field at a respective second location of the respective second power element.

2. The bearing of claim 1, wherein:
the bearing includes a seal disposed between the first ring and the second ring;
the seal is operative to retain a lubricant in a space between the first ring and the second ring or to prevent ingress of a contaminant into the space;
the seal provides at least one of a first part attached to the first ring and a second part attached to the second ring; and
at least one of the first arrangement and the second arrangement is accommodated at the seal.

3. The bearing of claim 1, wherein:
the first arrangement provides a first one of the first power elements disposed between a first pair of the first magnetic elements; wherein
the first magnetic elements of the first pair are configured to generate the first components of the magnetic field having opposite orientations at a path traversed by the second arrangement with respect to the first arrangement; wherein
the second arrangement provides a second one of the second power elements disposed between a second pair of the second magnetic elements; and wherein
the second magnetic elements of the second pair are configured to generate the second components of the magnetic field having opposite orientations at a further path traversed by the first arrangement with respect to the second arrangement.

4. The bearing of claim 1, wherein:
the first arrangement provides a first one of the first power elements interposed in a first series of four or more of the first magnetic elements arranged in the circumferential direction; wherein
the first magnetic elements are configured to generate the first components of the magnetic field having a uniform first orientation at a path, traversed by the second arrangement with respect to the first arrangement; wherein
the second arrangement provides a second one of the second power elements interposed in a second series of four or more of the second magnetic elements arranged in the circumferential direction; wherein
the second magnetic elements are configured to generate the second components of the magnetic field that have a uniform second orientation at a further path, traversed by the first arrangement with respect to the second arrangement; and wherein
the first orientation equals the second orientation.

5. The bearing of claim 1, wherein:
the first arrangement provides a first alternating sequence of the first magnetic elements and the first power elements in the circumferential direction; wherein the second arrangement includes a second alternating sequence of the second magnetic elements and the second power elements in the circumferential direction; wherein
the first components of the magnetic field generated by the first magnetic elements have a uniform first orientation at a path traversed by the second arrangement; and wherein
the second components of the magnetic field generated by the second magnetic components have a uniform second orientation at a further path traversed by the first arrangement; and wherein
the first orientation equals the second orientation.

6. A machine comprising:
a first machine part,
a second machine part and
a bearing; the bearing comprises having a first ring and a second ring configured for coaxial rotation with respect to each other around an axis in a circumferential direction; wherein
the first ring has a fixed position with respect to the first machine part and the second ring has a fixed position with respect to the second machine part for enabling the first machine part and the second machine part to rotate relative to one another; wherein
the machine provides one or more electric or electronic circuits at at least one of the first machine part, the second machine part, and the bearing;
the machine including a generator for generating electric power in operational use of the bearing for supply of the one or more electric or electronic circuits; wherein
the generator provides a first arrangement mounted in a fixed position with respect to the first ring, and a second arrangement mounted in a fixed position with respect to the second ring; wherein
the first arrangement and the second arrangement are configured for coaxial rotation with respect to each other; wherein
the first arrangement extends in the circumferential direction with respect to the axis and provides:
one or more first magnetic elements, each respective one of the first magnetic elements being configured for generating a respective first component of a magnetic field; wherein
one or more first power elements, each respective one of the first power elements being configured for supplying a respective first amount of electric power upon experiencing a respective change in the magnetic field at a respective first location of the respective first power element; wherein
the second arrangement extends in the circumferential direction: wherein
one or more second magnetic elements, each respective one of the second magnetic elements being configured for generating a respective second component of the magnetic field; and wherein
one ore more second power elements, each respective one of the second power elements being configured for supplying a respective second amount of electric power upon experiencing a respective change in the magnetic field at a respective second location of the respective second power element.
